(19) United States
(12) Patent Application Publication
(10) Pub. No.: US 2012/0068590 A1
(43) Pub. Date: Mar. 22, 2012

(54) DOUBLE-LOCK STRUCTURE

(75) Inventors: Wan-Lai CHEN, Taipei County (TW); Tsung-Po CHANG, Taipei County (TW)

(73) Assignee: MARTAS PRECISION SLIDE CO., LTD., TAIPEI COUNTY (TW)

(21) Appl. No.: 12/886,792

(22) Filed: Sep. 21, 2010

(51) Int. Cl. E05B 65/44; A47B 88/10

(52) U.S. Cl. 312/333

(57) ABSTRACT

A double-lock structure includes a first module, a second module, a lock, at least one deflecting roller and a transmission element. The first module is installed at an end of a slide rail of each drawer. When one of the drawers is pulled open, other slide rails are linked and locked. The second module is installed on the first module for linking and locking the first module. The lock and the deflecting rollers are installed in a cabinet. An end of the transmission element is connected to the lock, and another end of the transmission element is passed through the deflecting rollers and then connected to the second module. When the lock is operated, the transmission element drives the second module and the first module to perform a drawer interlock to achieve a keylock effect, so as to reduce the manufacturing cost and provide both interlock and keylock functions.

### BACKGROUND OF THE INVENTION

1. Field of the Invention

The present invention relates to the field of cabinet locks, and more particularly to a double-lock structure with both drawer interlock and keylock functions.

2. Description of the Related Art

In general, a cabinet such as a cupboard, a desk cabinet, and a file cabinet includes a plurality of drawers arranged longitudinally from top to bottom and provided for categorizing stored objects or data files, and a plurality of slide rails installed between the drawers and the cabinet for pushing and pulling the drawers to facilitate placing the objects or data files. Each drawer becomes heavy after the objects or data files are stored into the drawer, so that after one or more drawers are pulled out, the center of gravity of the cabinet is shifted and the cabinet may even be tilted. Although the slide rails provide the effect of pushing and pulling the drawers easily with little effort, each drawer may slide out from the slide rails of the cabinet if the cabinet is tilted and the center of gravity of the cabinet is shifted instantly, and thus resulting in injuries of people or damages of objects. According to the safety specifications set forth by different countries, it is necessary to install an interlock device in the cabinet to assure the safety of its use, and the structural design of the interlock device aims at locking other drawers that are not opened and comes with no other locking effects.

In general, the keylock function of a cabinet is provided for protecting confidentiality and preventing others to open the cabinet without authority, and the keylock function is achieved by installing a shared lock on the cabinet, wherein the shared lock is connected at the locking position of each drawer, such that each drawer can be locked. The cabinet having both of the aforementioned keylock and interlock functions requires a larger internal space for installing the shared lock and the interlock device. Since there is no other connectivity between the shared lock and the interlock device and no common part existed in the structure that can be used, therefore the manufacturing and maintenance costs will be increased, and the maintenance, repair or replacement will be inconvenient.

In view of the aforementioned problems of the conventional interlock device and components of the shared lock, the present invention provides a double-lock structure with both interlock and keylock functions, and the double-lock structure comprises a lock with an interlock function added to a first module, two deflecting rollers, a transmission element and a second module, such that when the lock is operated to link the transmission element, the two deflecting rollers are provided for changing directions, and the second module is provided for driving the first module to produce an interlock effect for the unopened drawers, so as to achieve the keylock effect of the cabinet.

### SUMMARY OF THE INVENTION

Therefore, it is a primary objective of the invention to provide a double-lock structure having both interlock and keylock functions without requiring a shared lock structure, and the invention can significantly reduce the manufacturing and material costs as well as the cost for the conventional shared lock and interlock device.

Another objective of the present invention is to provide a double-lock structure without requiring the installation space for the shared lock to reduce the space occupied by the drawers, so as to improve the volume utility rate of the cabinet.

A further objective of the present invention is to provide a double-lock structure that can achieve the effects of improving the convenience of its installation, facilitating the maintenance, repair, and replacement, and lowering the cost.

To achieve the foregoing objectives, the present invention adopts the following technical measures and provides a double-lock structure applied in a cabinet, and the cabinet includes a plurality of drawers and slide rails, and the drawers are moved on the slide rails respectively, and the double-lock structure comprises: a plurality of first modules, installed at ends of the slide rails respectively; a second module, installed on one of the first modules; a lock, installed on the cabinet;
a plurality of deflecting rollers, installed in the cabinet; a transmission element, with an end connected to the lock, and another end passed through the deflecting rollers for changing directions, and the other end of the transmission element being connected to the second module; and at least one link element, installed between the first modules; thereby, when one of the drawers is moved, the first modules and the link element are linked to lock the other drawers, to achieve the drawer interlock function and when the lock is operated, the transmission element is pulled and the deflecting rollers are rotated backward to drive the second module to enable the first modules and the link element between the first modules, such that the interlock function together with the keylock function can be used for locking the drawers.

In a preferred embodiment, the first module further comprises a first base, a rivet, a turning disk, a first quick release, a position restoring bump and a first elastic element, wherein the first base and the turning disk are fixed onto the slide rail by the rivet respectively, and the position restoring bump and the first elastic element are disposed on the turning disk, and both ends of the first elastic element are connected to the first base and the turning disk respectively, and the first quick release is installed on another side of the first base, such that the position restoring bump can be pushed by the slide rail to drive and rotate the turning disk, and the first quick release is moved vertically along the first base, and the link element is provided for linking and turning the turning disks of the other first modules to lock the drawers.

In a preferred embodiment, the second module further comprises a second base, a second quick release, a slide block and a second elastic element, and the second base is disposed on the first base of one of the first modules, and the second quick release is installed on another side of the first base, and a side of the second elastic element is fixed onto the second base, and the slide block is slidably installed at an edge of the second quick release, and both sides of the slide block are connected to the second elastic element and the transmission element respectively, such that when the slide block is pulled by the transmission element to link the second quick release to latch the turning disk, and drive the first module to lock the drawer, the turning disks of the other first modules are linked and rotated by the link element to lock the other drawers, wherein the second base is an n-shaped structure having a fixing hole formed at an end and locked onto the first base, and a hook formed on another end for latching onto the first base, and the second base further includes a propping portion disposed therein and provided for pressing a surface of the slide block. In addition, a through hole and a fixing notch are formed at both ends of the second base respectively, and the through hole is provided for passing the transmission element, and the fixing notch is provided for fixing an end of the second elastic element to install the second base at the first base securely. In addition, the second quick release further includes a slide rail provided for installing the slide block, and the slide block includes a slide groove formed on aside corresponding to the slide rail and a chamfer formed on another side corresponding to the second base, and a pair of fixing notches are formed on other two sides for fixing the transmission element and the second elastic element respectively. The second elastic element has a fixing portion disposed separately at both ends of the second elastic element, and the transmission element also has a fixing portion disposed separately at both ends of the transmission element. A propping bump is formed on another side of the turning disk and rotated to push the first quick release and/or the second quick release. The aforementioned structure is designed for improving the convenience of the following operations.

### BRIEF DESCRIPTION OF THE DRAWINGS

FIG. 1 is a schematic view of an assembly in accordance with a preferred embodiment of the present invention;

FIG. 2 is a perspective front view of a double-lock structure in accordance with a preferred embodiment of the present invention;

FIG. 3 is an exploded front view of a double-lock structure in accordance with a preferred embodiment of the present invention;

FIG. 4 is a perspective rear view of a double-lock structure in accordance with a preferred embodiment of the present invention;

FIG. 5 is an exploded rear view of a double-lock structure in accordance with a preferred embodiment of the present invention;

FIG. 6 is a first schematic view of operating a keylock in accordance with a preferred embodiment of the present invention;

FIG. 7 is a second schematic view of operating a keylock in accordance with a preferred embodiment of the present invention; and

FIG. 8 is a schematic view of operating a drawer interlock in accordance with a preferred embodiment of the present invention.

### DETAILED DESCRIPTION OF THE PREFERRED EMBODIMENTS

The technical characteristics and effects of the present invention will be apparent with the detailed description of preferred embodiment together with the illustration of related drawings as follows.

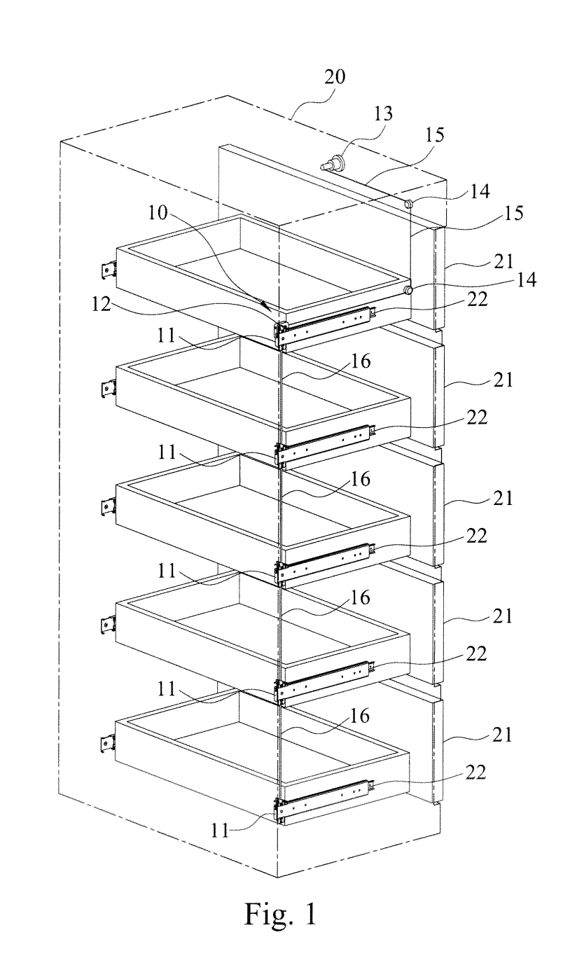

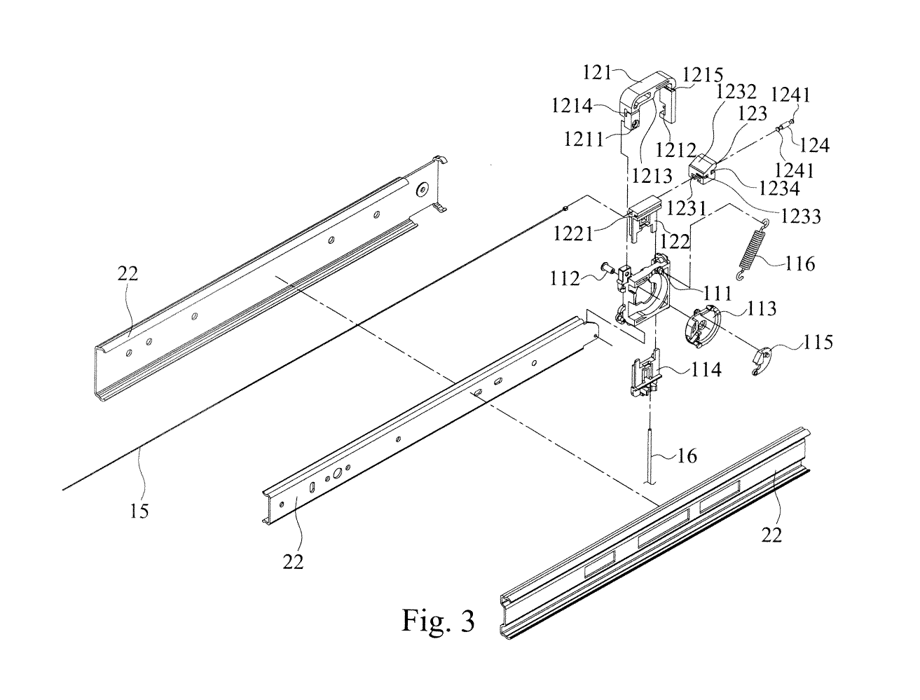

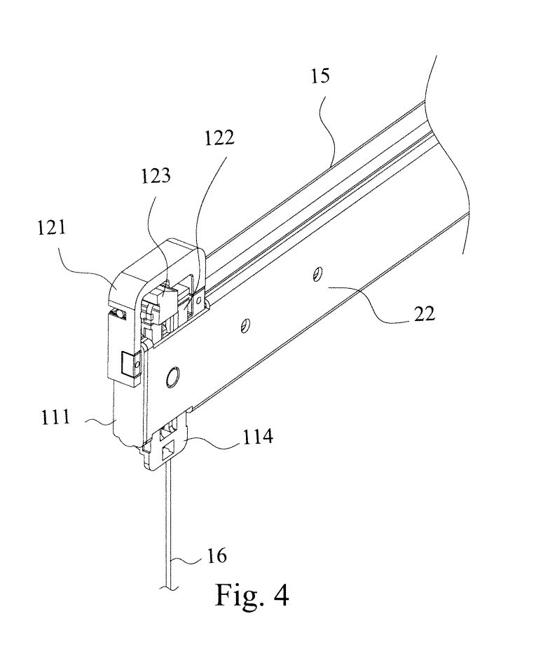

With reference to FIGS. 1 to 6 for a schematic view of an assembly, perspective views, and exploded views of a double-lock structure in accordance with a preferred embodiment of the present invention respectively, the double-lock structure 10 is applied in a cabinet 20, and the cabinet 20 includes a plurality of drawers 21 and slide rails 22, and the drawers 21 are moved on the slide rails 22 respectively, and the double-lock structure 10 includes a plurality of first modules 11, a second module 12, a lock 13, two deflecting rollers 14, a transmission element 15 and a plurality of link elements 16.

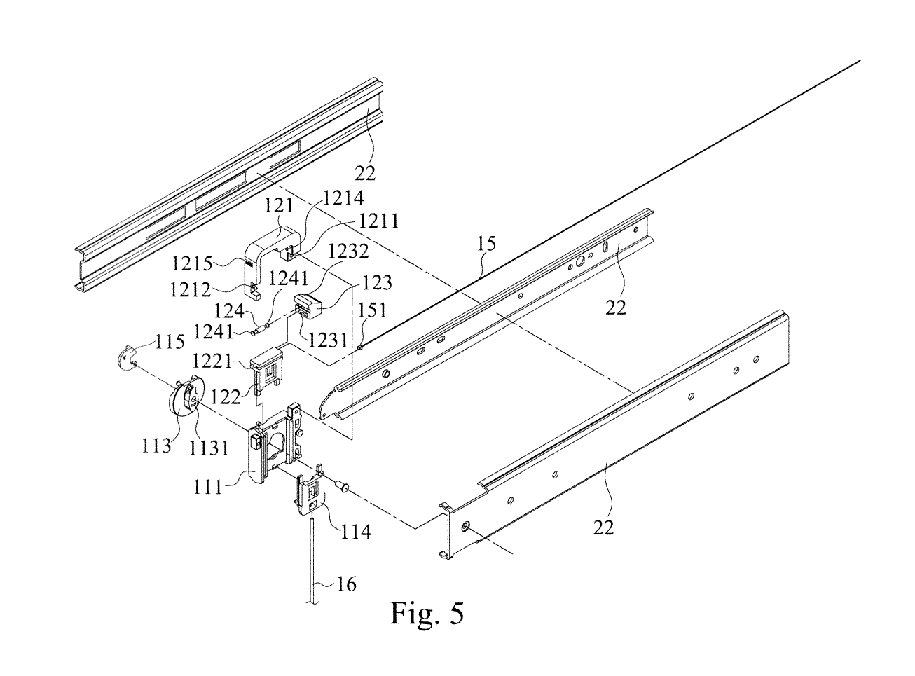

Each of the first modules 11 are installed at an end of the corresponding slide rail 22, and each of the first modules 11 further comprise a first base 111, a rivet 112, a turning disk 113, a first quick release 114, a position restoring bump 115 and a first elastic element 116 respectively. The first base 111 and the turning disk 113 are fixed onto the slide rails 22 by the rivet 112, and then the position restoring bump 115 and the first elastic element 116 are installed on a front side of the turning disk 113 respectively, and both ends of the first elastic element 116 are connected to the first base 111 and the a hook (not labeled with a number in the figure) of the turning disk 113 respectively for providing a pulling force required for restoring the turning disk 113 to its original position, and the first quick release 114 is installed on the back side of the first base 111. As shown in FIG. 5, the backside of the turning disk 113 includes a propping bump 1131, such that after the turning disk 113 is turned, the first quick release 114 is contacted with the propping pump 1131 and moved vertically with respect to the first base 111.

In FIG. 1, the second module 12 is installed at the upmost part of the first module 11, and the second module 12 further comprises a second base 121, a second quick release 122, a slide block 123 and a second elastic element 124. The second base 121 is an n-shaped structure having a fixing hole 1211 formed at an end of the second base 121 and locked onto the first base 111 and a hook 1212 disposed at another end of the second base 121 for latching the first base 111 to facilitate installing the second base 121 onto the first base 111 stably, and the second base 121 further contains a propping portion 1213 for propping a chamfer of the slide block 123, and a through hole 1214 and a fixing notch 1215 are formed at both ends of the second base 121 respectively, and the through hole 1214 is provided for passing an end of the transmission element 15, and the fixing notch 1215 is provided for fixing an end of the second elastic element 124. The second quick release 122 is installed on another side of the first base 111 (FIG. 1 shows that the first base 111 is on the top). In addition, the second quick release 122 further includes a slide rail 1221 provided for installing the slide block 123, and a slide groove 1231 is formed on a surface of the slide block 123 and corresponding to the slide rail 1221, and the chamfer 1232 is disposed on another surface of the slide block 123 and corresponding to the propping portion 1213 of the second base 121, and a pair of fixing notches 1233, 1234 are formed on both lateral surfaces of the slide block 123 and corresponding to the transmission element 15 and the second elastic element 124 respectively. In addition, a fixing portion 1241 is disposed separately at both ends of the second elastic element 124 and installed on the second base 121 and the slide block 123 separately for providing a pulling force required for restoring the slide block 123 to its original position. Since both lateral sides of the slide block 123 are connected to the second elastic element 124 and the transmission element 15 respectively, therefore the slide block 123 can be pulled by the transmission element 15 to link the second quick release 122 to latch the turning disk 113, so as to achieve the effect of driving the first module 11 to lock the drawer 21, and the link elements 16 are linked with the turning disks 113 of the other first modules 11 to turn the turning disks 113 in order to lock the other drawers 21.

In FIG. 1, the lock 13 is installed on the cabinet 20, and an end of the lock 13 is exposed from a surface of the cabinet 20, and another end of the lock 13 is installed into the cabinet 20, so that the lock 13 can be operated and turned.

In FIG. 1, the two deflecting rollers 14 of the present invention are installed at the top inside the cabinet 20 and on a lateral side of the first drawer 21 respectively.

A fixing portion 151 is disposed separately at both ends of the transmission element 15, and the fixing portion 151 includes an end connected to the lock 13, and another end passed through the two deflecting rollers 14 sequentially for making changes of directions twice, and the fixing portion 151 at the other end of the transmission element 15 is connected to the slide block 123 of the second module 12.

The link elements 16 are installed between the first modules 11, and both ends of each link element 16 are installed between the first quick releases 114 of any two adjacent first modules 11.

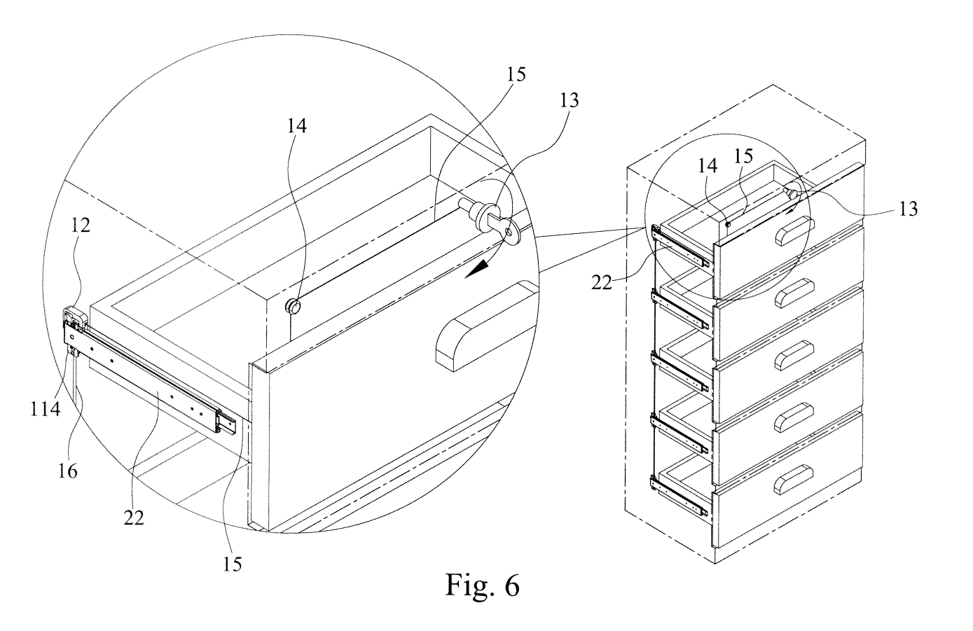

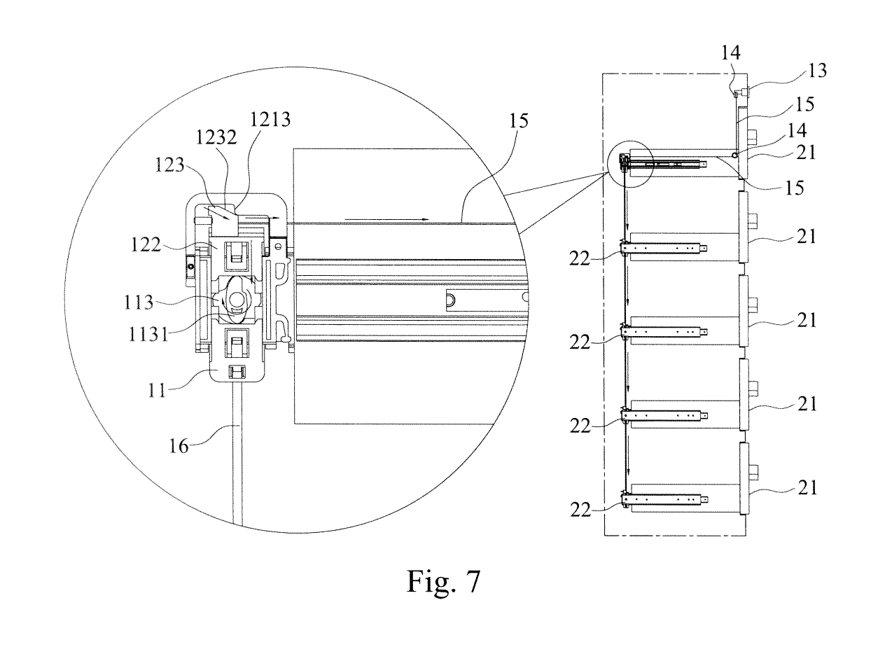

With reference to FIGS. 6 and 7 for schematic views of operating a keylock in accordance with a preferred embodiment of the present invention together with FIG. 1, the lock 13 is turned by a key during a keylock operation, and the turning of the lock 13 will roll and pull the transmission element 15. such that the transmission element 15 will be wound onto the lock 13 to shorten its length. After the transmission element 15 has made changes of directions twice by the two deflecting rollers 14, the transmission element 15 is rolled in a direction parallel to the slide rail 22. When the transmission element 15 drives the slide block 123 of the second module 12 to move forward, the chamfer 1232 is propped by the propping portion 1213 of the second base 121 to move forward and downward by the movement of the slide block 123 and drive the second quick release 122 to move downward synchronously to push the propping bump 1131 of the turning disk 113 to enable the link between the first modules 11 and the link elements 16, and the interlock function of the first modules 11 is used for achieving the keylock function to lock the drawers 21.

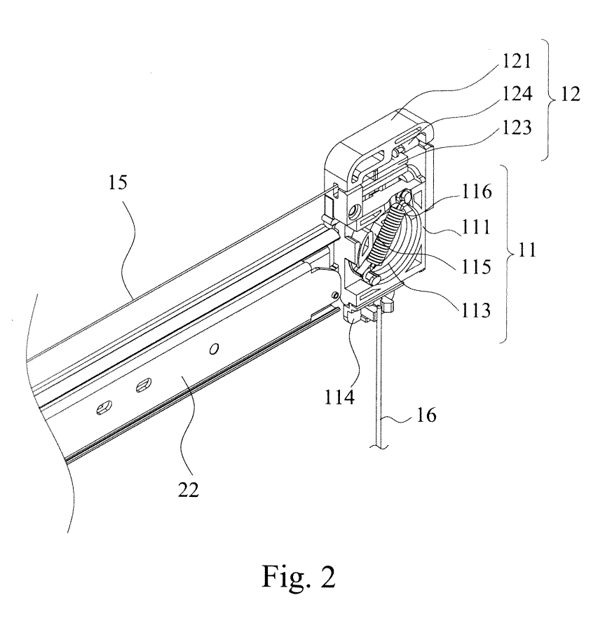

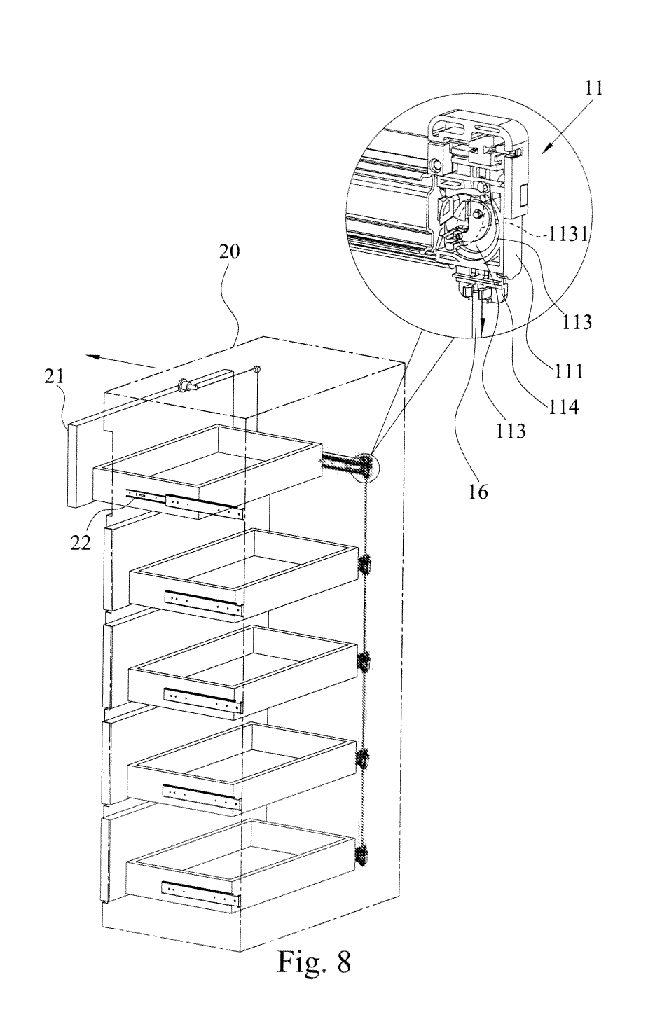

With reference to FIG. 8 for a schematic view of operating a drawer interlock in accordance with a preferred embodiment of the present invention, and together with reference FIGS. 2 to 5, when one of the drawers 21 of the cabinet 20 is pulled open and used, the slide rails 22 will be pulled simultaneously, such that after a portion of the slide rail 22 is driven by the position restoring bump 115 to link and rotate the turning disk 113 synchronously, and the propping bump 1131 of the turning disk 113 pushes the first quick releases 114, so that the first quick releases 114 are moved vertically along the first base 111, and the linking action of the link elements 16 drives and turns the turning disks 113 of the other first modules 11, so as to lock each of the other drawers 21. On the other hand, when the drawer 21 is pushed into the cabinet, then the aforementioned components will be operated in a reverse order to return the drawers 21 to a released status, and such operation is a common technique well known to the people ordinarily skilled in the art and thus will not be described here.

While the invention has been described by means of specific embodiments, numerous modifications and variations such as the quantity and installation position of the deflecting rollers. The quantity of the first modules, or the material of the first and second modules could be made thereto by those generally skilled in the art without departing from the scope and spirit of the invention set forth in the claims.

What is claimed is:

1. A double-lock structure, applied in a cabinet, and the cabinet including a plurality of drawers and slide rails, and the drawers being moved on the slide rails respectively, and the double-lock structure comprising:
a plurality of first modules, installed at ends of the slide rails respectively;
a second module, installed on one of the first modules;
a lock, installed on the cabinet;
a plurality of deflecting rollers, installed in the cabinet:
a transmission element, with an end connected to the lock, and another end passed through the deflecting roller for changing a direction, and the other end of the transmission element being connected to the second module; and
at least one link element, installed between the first modules;
wherein, when one of the drawers is moved, the first modules and the link element are linked to lock the other drawers, and when the lock is operated, the first modules, the second module, the transmission element and the link element are linked to lock the drawers.

2. The double-lock structure of claim 1, wherein the transmission element includes a fixed portion disposed separately at both ends of the transmission element.

3. The double-lock structure of claim 1, wherein the first modules further includes a first base, a rivet, a turning disk, a first quick release, a position restoring bump and a first elastic element, and the first base and the turning disk are fixed onto the slide rail by a rivet, and the position restoring bump and the first elastic element are disposed on the turning disk, and both ends of the first elastic element are connected to the first base and the turning disk respectively, and the first quick release is installed on another surface of the first base, such that the position restoring bump can be pushed by the slide rail to drive and turn the turning disk, and the first quick release moves vertically along the first base, and the link element links the turning disks of the other first modules to turn the turning disks to lock the drawers.

4. The double-lock structure of claim 3, wherein the second module further includes a second base, a second quick release, a slide block and a second elastic element, and the second base is disposed on the first base of one of the first modules, and the second quick release is installed on another side of the first base, and a side of the second elastic element is fixed onto the second base, and the slide block is slidably installed at an edge of the second quick release, and both sides of the slide block are connected to the second elastic element and the transmission element respectively, such that when the slide block is pulled by the transmission element to link the second quick release to latch the turning disk and link the first module to lock the drawer, the link element is linked to turn the turning disks of the other first modules to lock the other drawers.

5. The double-lock structure of claim 4, wherein the second base is an n-shaped structure having a fixing hole formed at an end of the second base and provided for locking the first base, and a hook disposed at another end of the second base and provided for hooking the first base, and the second base further includes a propping portion formed therein and provided for pressing a lateral side of the slide block,

6. The double-lock structure of claim 4, wherein the second base further includes a through hole and a fixing notch formed at both ends of the second base respectively, and the through hole is provided for passing the transmission element, and the fixing notch is provided for fixing an end of the second elastic element.

7. The double-lock structure of claim 4, wherein the second quick release further includes a slide rail for installing the slide block, and the slide block includes a slide groove formed on a side corresponding to the slide rail, a chamfer formed on another side corresponding to the second base, and fixing notches formed on both sides and fixed to the transmission element and the second elastic element respectively.

8. The double-lock structure of claim 4, wherein the second elastic element includes a fixing portion separately disposed at both ends of the second elastic element.

9. The double-lock structure of claim 4, wherein the turning disk further includes a propping bump formed on another side of the turning disk, and the turning disk is turned to press the first quick release and/or the second quick release.
